(19) United States
(12) Patent Application Publication
(10) Pub. No.: US 2007/0067319 A1
(43) Pub. Date: Mar. 22, 2007

(54) System for building up hyperlinks of key words within text provided by content website

(76) Inventors: Chih-Hung Chang, Taipei City (TW); You-Chieh Tsai, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/227,174

(22) Filed: Sep. 16, 2005

(51) Int. Cl. G06F 7/00

(52) U.S. Cl. 707/100

(57) ABSTRACT

A hyperlink building system includes a key word database and an add-in module. The key word database has a plurality of advertisement key words stored therein and each of the advertisement key words corresponding to a uniform resource locator (URL) address. The add-in module is used to process a content web page including the advertisement key words and make the advertisement key words become hyperlinks relating to the URL addresses. Therein, when one of the key words is clicked by a mouse, a web page relating to the one of the key words (i.e. content web page or advertisement web page) is activated.

### BACKGROUND OF THE INVENTION

1. Field of the Invention

The present invention is related to a system for building up hyperlinks of key words within text provided by a content website, and more particularly, to a system that can be used to build up hyperlinks of key words that appears in text provided in web pages of a website and is related to advertisements.

2. Description of Related Art

With the development of Internet advertisements, many companies invest in this market. For this sake, the techniques related to this field progress rapidly. Among the companies that invest in the Internet advertisement market, Overture Services and Google Companies that provide content-oriented advisement services are the most popular ones.

The mode of providing content-oriented advisement services resolves the problems that conventional Internet advertisements usually have a very low probability to be viewed. Before the content-oriented advisements are provided, clients need to choose some key words related to specific advertisements. Then, the clients only need to pay according to the number of that the specific advertisements are viewed. For example, if a client chooses “automobile” as a key word, the uniform resource locator (URL) addresses of advertisements related to the key word provided by the client will be listed in the front of the search result when the key word “automobile” is searched by the search engine. A user who searches web pages with a specific key word usually is a consumer who is interested in the products related to the key word. Hence, this kind of advertisement marketing method that meets the requirements of users is superior to the conventional ones.

Enterprises can use the content-oriented advisement services to impress the target people and thus makes these people obtain information related thereto. In this procedure, the enterprises can also obtain the information related to these target people and thereby know the web page browsing habits of consumers with lower cost. In this way, the enterprises can figure out marketing methods closer to the needs of consumers and make more profits thereby.

However, the content-oriented advisement service mode does not considerably benefit general content websites, such as news websites or Blog websites. Many content websites cooperate with content-oriented advisement service providers, similar to Overture Services and Google Companies, to provide search engines and content-oriented advisements, and shares the advertisement incomings. But this cooperation mode is not very profitable because users connect to contents websites usually not for searching specific key words. Compared with the web pages provided by the content websites, the search engines are not often used. Thus, the viewing rate of the content-oriented advisements is very low. Therefore, the advertisement incomings do not benefit the content websites very much, and the cost for providing the contents of web pages cannot be balanced.

In fact, the text in contents of web pages provided by content websites includes a lot of key words that are useful for advertisements. Hence, in order to increase the advertisement incomings of content websites, the mode for providing content-oriented advisement services needs to be modified.

### SUMMARY OF THE INVENTION

An objective of the present invention is to provide a system for building up hyperlinks of key words within text provided by a content website. The system of the present invention is used to build up hyperlinks related to advertisement key words included in the contents of web pages. In this way, when a user clicks the key words, the hyperlink function is activated to let him connect to the web pages related to the key words.

Another objective of the present invention is to provide a system for building up hyperlinks of key words within text provided by a content website. The system of the present invention reduces the loading of the server and improves overall system operation efficiency by modifying the operating sequence of the add-in module.

Still another objective of the present invention is to provide a system for building up hyperlinks of key words within text provided by a content website. The system of the present invention can build up hyperlinks related to some advertisement key words that appear in content web pages. In this way, the content website providers can attract more people to connect to specific Internet advertisements via the hyperlinks of the advertisement key words and thereby gains more advertisement incomings. For achieving the objective above, the present invention provides a hyperlink building system, including a key word database and an add-in module. The key word database has a plurality of advertisement key words stored therein and each of the advertisement key words corresponding to a uniform resource locator (URL) address. The add-in module is used to process a content web page including the advertisement key words and make the advertisement key words become hyperlinks relating to the URL addresses. Therein, when one of the key words is clicked by a mouse, an advertisement web page relating to the one of the key words is activated.

Numerous additional features, benefits and details of the present invention are described in the detailed description, which follows.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic diagram of a system for building up hyperlinks of key words within text provided by a content website in accordance with the present invention;

FIGS. 2A-B are schematic diagrams of the first embodiment of the present invention;

FIG. 3 is a schematic diagram of the second embodiment in accordance with the present invention;

FIG. 4 is a schematic diagram of the third embodiment in accordance with the present invention; and

FIG. 5 is a schematic diagram of a content web page produced in accordance with the present invention. In the present invention.

### DETAILED DESCRIPTION OF PREFERRED EMBODIMENTS

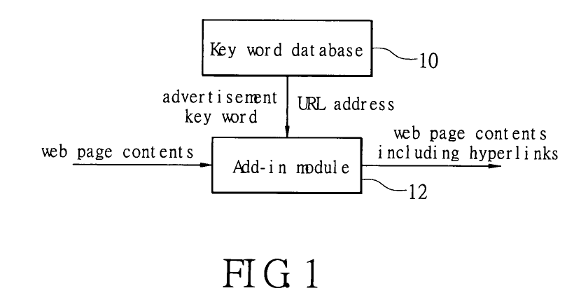

Reference is made to FIG. 1, which is a schematic diagram of a system for building up hyperlinks of key words within text provided by a content website in accordance with the present invention. As shown in FIG. 1, the system of the present invention includes a key word database 10 and an add-in module 12. The key word database 10 has multiple advertisement key words pre-stored therein. Each advertisement key word corresponds to a URL address. The add-in module 12 is used to perform a hyperlink-building procedure. In other words, the add-in module 12 is used to build up the hyperlinks between the key words and the corresponding web pages.

In brief, the system of the present invention uses the add-in module 12 to check whether the contents of the web pages contain the advertisement key words. If positive, the add-in module 12 builds up the hyperlinks between the key words and the corresponding web pages and passes the contents of the web pages with hyperlinks to other devices. Otherwise, the add-in module 12 does nothing but passes the contents of the web pages to other devices. In the following, how to obtain the advertisement key words, when to build up the hyperlinks, how to produce the web pages, how to select the URL addresses corresponding to the hyperlinks, and how to operate when the hyperlink function is activated will be described in detail. The advertisement key words stored in the key word database 10 are similar to the key words used in the conventional content-oriented advisement services and can be acquired in various ways. For example, the advertisement key words of the present invention can be the word strings usually searched by the search engines owned by content websites, Overture Corporation or Google Corporation, or the key words sold by Internet advertisement companies. Hence, the advertisement key words of the present invention can be names of people, companies, or things (i.e. automobile), depending on the contents of content websites. In other words, if the content of a website relates to flowers, the advertisement key words can be names of flowers. Thus, meaningless analysis procedure is reduced.

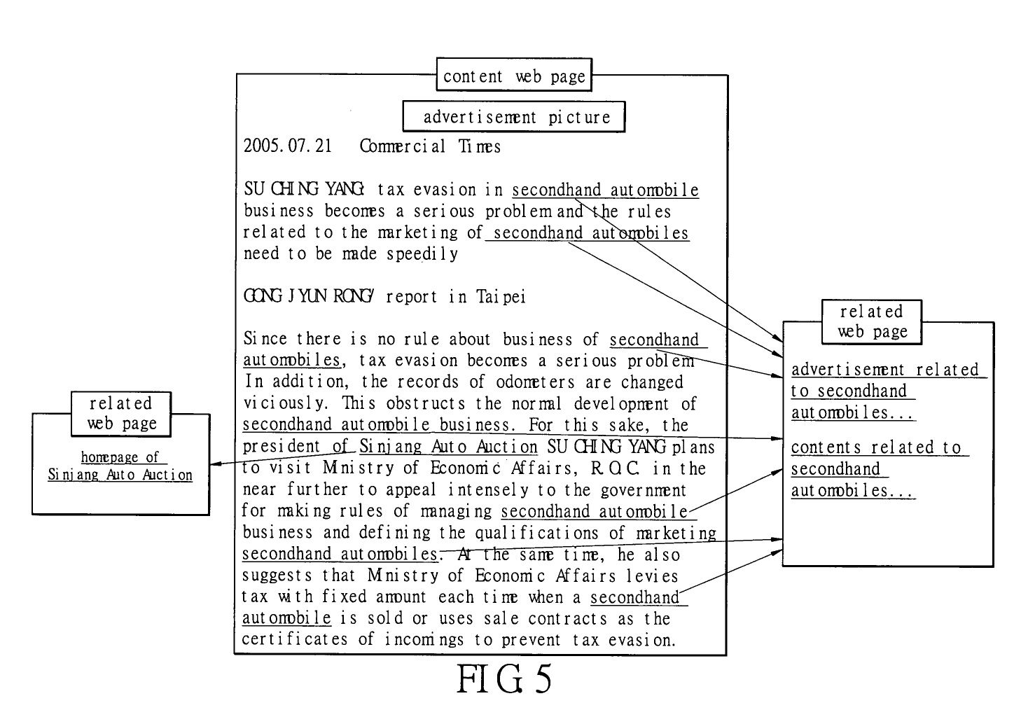

In short, the web pages of the content website produced by the system of the present invention (an example is shown in FIG. 5, which will be explained later) can be viewed by people and the key words within the web pages can be selected by mice to activate related web pages (as shown in FIG. 5) via the hyperlink function.

The sequence of producing web pages and building hyperlinks seriously affects the operation efficiency of the system of the present invention. In other words, the add-in module 12 may need to build up hyperlinks of web pages that are produced dynamically or inputted statically and processing different kinds of web pages seriously affects the operation efficiency of the system of the present invention. In addition, the operation of the add-in module 12 may be performed by the server or the client end and different operating devices also affect the operation efficiency of the system of the present invention. In the following, the first embodiment, the second embodiment, and the third embodiment are used for explaining these situations.

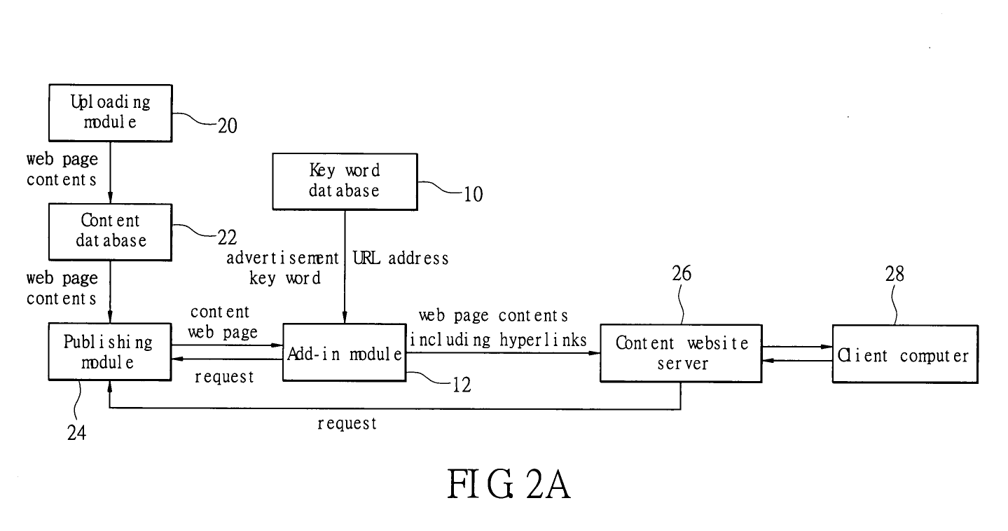

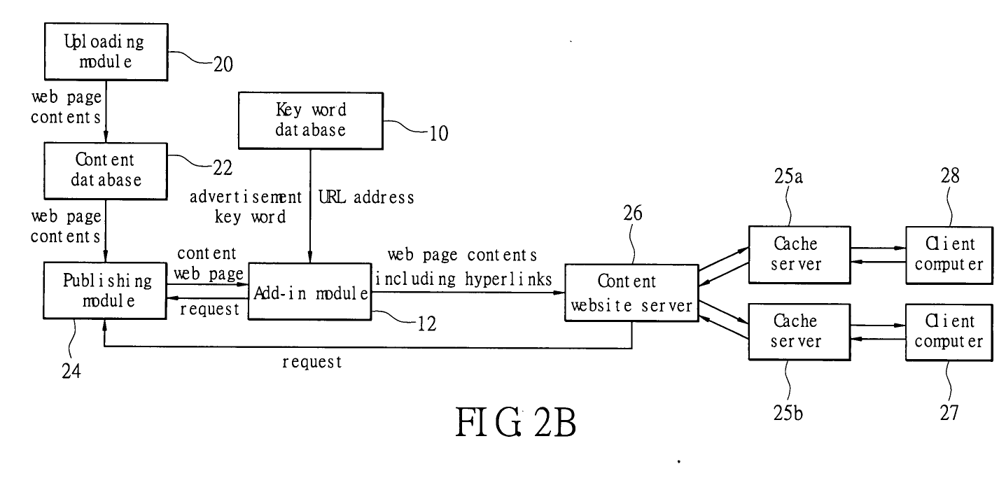

Reference is made to FIGS. 2A-B, which are schematic diagrams of the first embodiment of the present invention. As shown in FIG. 2A, in order for producing web pages that are capable of being viewed via the browser of the client computer 28 and the need of management, the system of the present invention further includes an uploading module 20, a content database 22, a publishing module 24, and a content website server 26, except for the key word database 10 and the add-in module 12.

As shown in FIG. 2A, for the need of management, especially for the content website companies having a lot of writing or editing personnel, if all of the content of the web pages are inputted and uploaded by a specific department or specific personnel, the efficiency will be very low and the cost will be increased. Hence, most of content website companies prefer to provide the uploading module 20 so that the writing and editing personnel can upload the contents of web pages themselves. After the writing and editing personnel upload the contents of web pages, the uploading module 20 passes the contents of web pages to the content database 22 and stores them into the same.

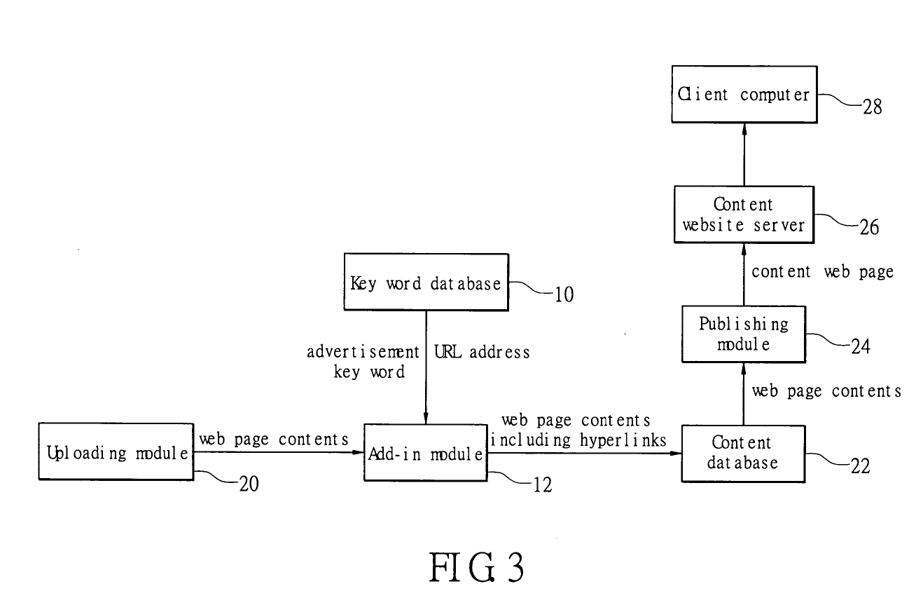

In the first embodiment, the publishing module 24 arranges the contents of web pages stored in the content database 22 according to predetermined editing rules and makes them form content web pages capable of being viewed. Then, the content web pages are placed on the content website sever 26. However, in order to execute the hyperlink building procedure shown in FIG. 1, the content web pages need to be processed before being placed on the content website sever 26. In addition, for improving the efficiency, in the second embodiment as shown in FIG. 3, the content web pages are not uploaded directly to the content database 22 but processed by the add-in module 12 in advance.

In the first embodiment, the timing for the add-in module 12 to process the content web pages depends on the types of content websites. For news websites that have predictable contents, the add-in module 12 can issue a request command to the publishing module 24 to obtain the content web pages produced therefrom. In this way, the add-in module 12 can perform the hyperlink building process in advance and then pass the processed content web pages to the content website server 26. In addition, if the content website server 26 doesn't have the content web pages required by the client computer 28, it will send a request command to the publishing module 24. Similarly, the content web pages are also processed by the add-in module 12 before being delivered to the content website server 26.

If the content web page that will be placed on the website is a homepage of a website, the so-called editing rule may include accessing pictures, titles of last web page contents uploaded to the content database 22, and so on according to specific paths of files, and using these materials to form a content web page. If the content web page that will be placed on the website is a web page linked to a specific title of a homepage, the editing rule may include accessing advertisement pictures and web page pictures according to specific paths of files, and obtaining corresponding web page contents from the content database 22.

Therefore, according to the operation procedure of the first embodiment, namely producing content web pages first and then building hyperlinks, for the content website with a low pageview rate, the additional hyperlink building procedure can be performed normally without increase of additional servers. However, for the content website with a high pageview rate, the content website needs to produce web pages and build up hyperlinks simultaneously when a user requires to browse the web pages and thus the loading of the server of the content website is increased. Hence, another operation procedure more efficient than that of the first embodiment is required. Otherwise, the number of servers and the cost will be increased. Although using the buffer servers 25a, 25b as shown in FIG. 2B can provide a higher capability to satisfy the browsing requirements of users (for example, the clients computers 28, 27 can obtain the web page contents respectively from the buffer servers 25a and 25b), the overall cost is still increased.

Reference is made to FIG. 3, which is a schematic diagram of the second embodiment in accordance with the present invention. As shown in FIG. 3, the second embodiment, as the first embodiment, includes the key word database 10, the add-in module 12, the uploading module 20, the content database 22, the publishing module 24, and the content website server 26. However, the system structure of the second embodiment is different to that of the first embodiment and can improve the overall operation efficiency effectively. Compared with the first embodiment, the web page contents provided by the uploading module 20 of the second embodiment are first processed by the add-in module 12 and then stored into the content database 22. But the client computer 28 still needs to access the content website sever 26 for browsing the content web pages.

Concretely speaking, in the second embodiment, the add-in module 12 is first used to process the web page contents having advertisement key words to build up hyperlinks related to specific URL addresses, and the web page contents is then stored into the content database 22. Lastly, the web page contents are provided for the content website server 26. In this way, the procedures of producing web pages and building hyperlinks do not need to be performed simultaneously. Although the web pages still need to be produced each time when users send a request, the hyperlink-building procedure only needs to be performed one time in the second embodiment. Hence, the second embodiment as shown in FIG. 3 can surely reduce the loading of the content website server 26, especially when many users require to browse the content web pages.

However, in the hyperlink-building procedure, the add-in module 12 needs to analyze every word strings and build up hyperlinks when advertisement key words are found. Hence, executing the hyperlink-building procedure is a heavy burden to servers. Perhaps for this sake, many content websites cannot build up hyperlinks related to advertisement key words in every content web page due to limited system resources. Hence, although the second embodiment reduces the loading of the content website sever, it still relies on the content website server.

In addition, since the hyperlink-building procedure of the second embodiment is performed by the add-in module 12 before the web page contents are stored into the content database 22, the advertise key words of the second embodiment cannot be changed flexibly. In other words, although the second embodiment increases the operation efficiency, the key words of the web pages that have been processed by the add-in module 12 are difficult to be changed according to the newly variation of the of the advertisement key words stored in the key word database 10. It is a problem especially for Blog content websites, whose contents change quickly.

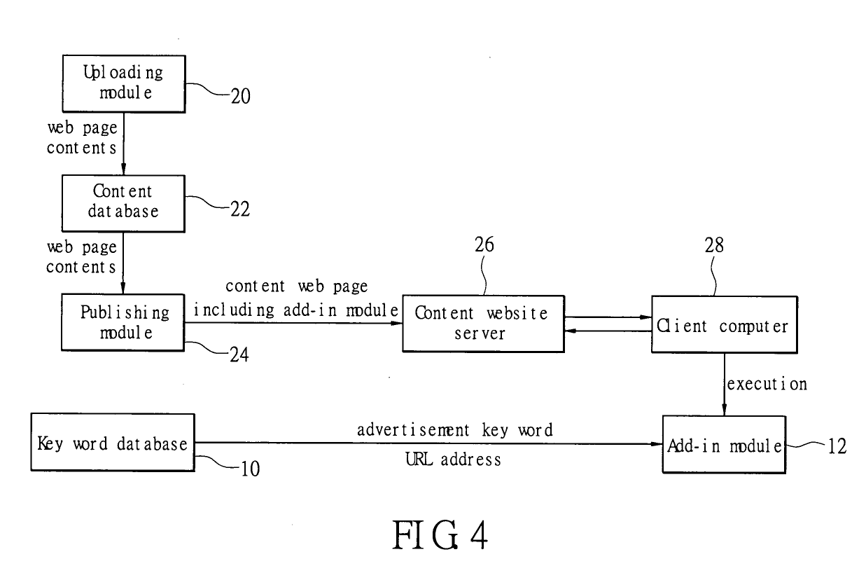

Reference is made to FIG. 4, which is a schematic diagram of the third embodiment in accordance with the present invention. As shown in FIG. 4, the third embodiment, as the first embodiment, includes the key word database 10, the add-in module 12, the uploading module 20, the content database 22, the publishing module 24, and the content website server 26. However, the system structure of the third embodiment is different to that of the first embodiment

In the third embodiment, the publishing module 24 not only combines multiple web page contents stored in the content database 22 to produce content web pages according to the editing rules, but also adds a Javascript program served as the add-in module 12 into the content web pages. In this way, the operation of the add-in module 12 is not necessary to be performed by the server but by the browser of the client computer 28.

Concretely speaking, after the publishing module 24 adds the Javascript program of the add-in module 12 into the content web pages, it passes the content web pages to content website 26. When the content web pages including the publishing module 24 are downloaded from the content website server 26 to the client computer 28, the browser of the client computer 28 will execute the add-in module 12 to building up hyperlinks of the content web pages according to the advertisement key words and the corresponding URL addresses stored in the key word database 10.

In this way, the server doesn't need to process the heavy-loaded operation procedure. It only needs to add the Javascript program of the add-in module 12 into the content web pages. Moreover, the client computer 28 only needs to execute the add-in module 12 to build up the hyperlinks of a few content web pages that are requested. This will not burden the client computer 28 too much. Hence, the third embodiment shown in FIG. 4 has a simpler structure and lower cost.

Reference is made to FIG. 5, which is a schematic diagram of a content web page produced in accordance with the present invention. In the present invention, the first, second, and third embodiments can produce the same content web page as shown in FIG. 5.

For example, if the advertisement key words stored in the key word database 10 include “Sinjang Auto Auction” and “secondhand automobile”, the add-in module 12 will build up the hyperlinks related to “Sinjang Auto Auction” and “second-hand automobile” that appears in the web page shown in FIG. 5, i.e. the web page having the news about Sinjang Auto Auction. The hyperlinks are linked to the homepage of the Sinjang Auto Auction, the homepages of secondhand automobile providers, and web pages about activities related to automobiles. Hence, when a user reads the web page shown in FIG. 5, he can click the hyperlink of “Sinjang Auto Auction” and thereby connects to the homepage of the Sinjang Auto Auction. Furthermore, the user can also click the hyperlink of “secondhand automobile” and thereby connects to the homepages of secondhand automobile providers, and web pages about activities related to automobiles.

However, selling the key word “Sinjang Auto Auction” to a competitor of Sinjang Auto Auction to let users connect to the web pages of the competitor is not a good idea. As for the key word, “Secondhand automobile”, it is not a specific key word. In order to prevent users from having a bad feeling about the key word advertisements provided by the present invention, the hyperlink of the “Secondhand automobile” lets users connect not to advertisements but to a title list of news or information about automobiles.

As the example shown in FIG. 5, it shows a content web page about news. Since the contents of the content web page are comprehensive and have a high probability to include the advertisement key words, performing the hyperlink-building procedure on all of the contents without executing a classification procedure or performing a learning mechanism in advance is not meaningless. However, if the content web page belongs to content websites with specific contents or Blog websites, for example, the content website related to discussion or information of flowers, it is meaningless to perform the hyperlink-building procedure on the contents of this web page according to the “Sinjang Auto Auction” and “second-hand automobile” because these two key words have a very low probability to appear in this web page. Hence, before the hyperlink-building procedure is performed on a web page, a few key words stored in the key word database 10 that is almost impossible to appear in the web page can be removed in advance.

To sum up, the system of the present invention can build up hyperlinks related to some advertisement key words that appears in content web pages. In this way, the content website providers can attract more people to connect to specific Internet advertisements via the hyperlinks of the advertisement key words and thereby gains more advertisement incomings.

In addition, except the components mentioned above, the present invention can also provide a reporting form for key word buyers or a managing form needed for inner management according to the connection records of advertisements.

Although the present invention has been described with reference to the preferred embodiments thereof, it will be understood that the invention is not limited to the details thereof. Various substitutions and modifications have been suggested in the foregoing description, and others will occur to those of ordinary skill in the art. Therefore, all such substitutions and modifications are embraced within the scope of the invention as defined in the appended claims.

What is claimed is:

1. A hyperlink building system, comprising:
a key word database having a plurality of advertisement key words stored therein and each of the advertisement key words corresponding to a uniform resource locator (URL) address; and
an add-in module used to process a content web page including the advertisement key words and make the advertisement key words become hyperlinks relating to the URL addresses;
wherein when one of the key words is clicked by a mouse, an advertisement web page relating to the one of the key words is activated.

2. The hyperlink building system as claimed in claim 1, further comprising:
a content database used to store a plurality of web page contents; and
an uploading module providing a operation interface for people to upload the web page contents.

3. The hyperlink building system as claimed in claim 2, wherein the web page contents uploaded by the uploading module is first processed by the add-in module and then passed to the content database, and the advertisement key words included in the web page contents become the hyperlinks after processed by the add-in module.

4. The hyperlink building system as claimed in claim 2, further comprising:
a publishing module used to arrange the web page contents stored in the content database according to a predetermined editing rule to form the content web page and then place the content web page onto a content website server.

5. The hyperlink building system as claimed in claim 4, wherein before the content web page is placed onto a content website server by the publishing module, the content web page is processed by the add-in module to make the advertisement key words become the hyperlinks.

6. The hyperlink building system as claimed in claim 2, further comprising:
a publishing module used to arrange the web page contents stored in the content database according to a predetermined editing rule to form the content web page, place the add-in module into the content web page as a Javascript program, and then place the content web page onto a content website server;
wherein when the content web page that has the add-in module is downloaded to a client computer, a browser of the client computer activates the add-in module to make the advertisement key words become the hyperlinks.

7. The hyperlink building system as claimed in claim 1, wherein the advertisement web page includes content and an advertisement related to the advertisement key words.
